(19) United States
(12) Patent Application Publication
(10) Pub. No.: US 2005/0073715 A1
(43) Pub. Date: Apr. 7, 2005

(54) Printing system and method of controlling thereof

(75) Inventors: Mamoru Sakai, Kawasaki-shi (JP); Mikihiro Kajihara, Matsumoto-shi (JP); Hiroshi Ono, Tokyo (JP); Yoichi Hine, Tokyo (JP)

Correspondence Address: HOGAN & HARTSON L.L.P., 500 S. GRAND AVENUE, SUITE 1900, LOS ANGELES, CA, 90071-2611, US

(73) Assignees: SEIKO EPSON CORPORATION; KING JIM CO., LTD.

(21) Appl. No.: 10/918,666

(22) Filed: Aug. 13, 2004

(30) Foreign Application Priority Data
Sep. 16, 2003 (JP) 2003-322682

(51) Int. Cl. G06F 15/00; H04N 1/23

(52) U.S. Cl. 358/1.15

(57) ABSTRACT

In a printing system which causes a printing apparatus to perform printing based on print data generated by a data-generating apparatus, plural types of printing apparatuses which can be connected to the printing system include model information inherent in each model. The data-generating apparatus includes: editing functions for generating print data by editing input data; a database which correlates all model information with the editing functions possessed by the plurality of types of printing apparatuses based on printing functions; a model-information acquiring device for acquiring model information of the connected printing apparatuses; a function-specifying device for specifying an editing function not supported by the printing apparatus in view of the acquired model information based on the database; and a function-limiting device for limiting use of the unsupported editing function. It is thus possible to prevent disagreement between the user's print images prior to printing and actual print results from occurring.

### BACKGROUND OF THE INVENTION

1. Field of the Invention

The present invention relates: to a printing system in which a data-generating apparatus for generating print data and a printing apparatus for performing printing based on the print data are connected to each other through an interface; and to a method of controlling thereof.

2. Description of the Related Art

Conventionally, there is known a printing system in which a data-generating apparatus constituted of a personal computer or the like is connected to a printing apparatus (i.e. printer), causing the printing apparatus to perform printing based on print data generated by the data-generating apparatus. The data-generating apparatus includes a display, a keyboard, a mouse, and a controlling unit. In the controlling unit are stored various control programs for inputting and editing print data, and a control table including various conversion tables. The user operates the keyboard and the mouse while viewing the display, which enables inputting and editing of print data.

It should be noted that some of editing functions of the data-generating apparatus depend on printing functions of the printing apparatus to be connected, and when print data is generated by the use of the editing function not supported by the printing functions of the connected printing apparatus, desired print results may not be achieved in some cases. Thus, if such a printing system is arranged such that a plurality of types of printing apparatuses, each having a different printing function, can be connected to the data-generating apparatus, the editing functions supported only by limited printing apparatuses will be present as a consequence. Some printing apparatuses to be connected to the printing system may therefore fail to print print data properly. In other words, if print data has been generated by the use of the printing functions not supported by the connected editing apparatus, there arises a problem in that the user's print images prior to printing and actual print results disagree with each other depending on the generated print data.

### SUMMARY OF THE INVENTION

With respect to the above problem, the present invention has an advantage of providing a printing system arranged such that a plurality of types of printing apparatuses, each having a different printing function, can be connected to a data-generating apparatus, preventing disagreement between the user's print images prior to printing and actual print results with each other, as well as a method of controlling thereof.

According to one aspect of the present invention, there is provided a printing system arranged such that a plurality of types of printing apparatuses, each having a different printing function for proper printing, can be connected to a data-generating apparatus through an interface, thereby causing the printing apparatuses to perform printing based on print data generated by the data-generating apparatus, wherein the plurality of types of printing apparatuses comprise model information inherent in each model, and the data-generating apparatus comprises: a data-inputting means for inputting input data; a data-editing means having an editing function for editing the input data inputted and generating the print data; a database-storing means for storing a database which correlates all model information with the editing function possessed by the plurality of types of printing apparatuses based on the printing function; a model-information acquiring means for acquiring model information of the connected printing apparatus; a function-specifying means for specifying as an unsupported editing function the editing function not supported by the printing function of the connected printing apparatus in view of the acquired model information, based on the database; and a function-limiting means for limiting use of the specified unsupported editing function.

Further, according to another aspect of the present invention, there is provided a method of controlling a printing system arranged such that a plurality of types of printing apparatuses, each having a different printing function for proper printing, can be connected to a data-generating apparatus through an interface, thereby causing the printing apparatuses to perform printing based on print data generated by the data-generating apparatus, wherein the plurality of types of printing apparatuses comprise model information inherent in each model, and the data-generating apparatus has an editing function for editing input data inputted and generating the print data, and correlates all model information with the editing function possessed by the plurality of types of printing apparatuses based on the printing function and stores the same. The method comprises the steps of: acquiring the model information of the connected printing apparatus; specifying as an unsupported editing function the editing function not supported by the printing function of the connected printing apparatus in view of the acquired model information; and limiting use of the specified unsupported editing function.

According to the above configurations, the editing function not supported by the printing function of the connected printing apparatus, i.e. the editing function which may cause improper print results is specified as the unsupported editing function, and use of the function is limited. Hence, only the editing function supported by the connected printing apparatus is allowed for editing input data, so that the unsupported editing function is prevented from being used.

Preferably, the data-generating apparatus further comprises: an input-data detecting means for detecting whether or not the input data has been inputted upon being connected with the printing apparatus; and a canceling means for canceling an edit by the unsupported editing function when the input data is detected by the input-data detecting means.

According to the configuration, it is possible to cancel the edit even if input data has been inputted before the printing apparatus is connected to the data-generating apparatus, i.e. before the use of the unsupported editing function is limited, and the input data has been edited by the use of the unsupported editing function. Thus, print data can be converted such that it is supported by the connected printing apparatus, thereby preventing disagreement between the user's print images and actual print results with each other.

Preferably in this case, the data-editing means has a plurality of types of editing functions, and the data-generating apparatus further comprises a substitute-function setting means for setting substitute editing functions supported by the printing apparatus in place of the canceled unsupported editing function.

According to this configuration, the input data can be edited by the use of the substitute editing functions supported by the connected printing apparatus in place of the canceled unsupported editing function. It is thus possible to enhance the user's convenience and ease of operation when he or she desires to edit the input data to some extent without the edit by the canceled unsupported editing function.

### BRIEF DESCRIPTION OF THE DRAWINGS

The above and other objects and the attendant features of this invention will become readily apparent by reference to the following detailed description when considered in conjunction with the accompanying drawings wherein:

FIG. 1 is an explanatory drawing showing a configuration of a printing system according to an embodiment of the present invention;

FIG. 2 is a block diagram showing an apparatus configuration of a data-generating apparatus which constitutes the printing system;

FIG. 3 is an explanatory drawing showing an example of an input/edit screen in the data-generating apparatus;

FIG. 4 is an explanatory drawing exemplifying a tape printer applicable as a printing apparatus which constitutes the printing system, showing an external perspective view thereof;

FIG. 5 is an explanatory drawing of the tape printer in which are shown an external perspective view of a tape cartridge to be mounted on the tape printer, and an external perspective view of the tape printer with an opening/closing lid thereof opened;

FIG. 6 is a block diagram showing a control system of the tape printer;

FIG. 7 is a flow chart showing a series of processes from use limitation of an unsupported editing function to conversion of print data, which is performed upon the printing apparatus being connected to the data-generating apparatus (printing system);

FIGS. 8A to 8D each show contents of a database in which model information of the printing apparatus corresponds to individual editing functions of the printing system, wherein FIG. 8A is a diagram regarding a “transparent”-filling function and a “pattern”-filling function set by filling of a “character”-setting function, and a “gradation”-setting function of the character-setting function, FIG. 8B is a diagram regarding a “gradation”-setting function pertaining to filling of graphics, FIG. 8C is a diagram regarding a “background-pattern”-setting function, and FIG. 8D is a diagram regarding each margin-setting function displayed in a margin-setting list box;

FIGS. 9A and 9B are explanatory diagrams regarding conversion of print data, each showing substitute editing functions set in respective editing functions which constitute the individual editing functions, wherein FIG. 9A is a diagram showing the substitute editing functions substituted for the unsupported editing function with respect to input data of characters and graphics, and FIG. 9B is a diagram showing the substitute editing functions substituted for the unsupported editing function with respect to margins set when a label is formed;

FIGS. 10A and 10B are explanatory diagrams regarding the use limitation of the unsupported editing function, wherein FIG. 10A is a character-setting screen displayed when a tape printer “a” is connected, and FIG. 10B is a character-setting screen displayed when a tape printer “b” is connected;

FIGS. 11A to 11D are explanatory diagrams regarding the use limitation of the unsupported editing function, wherein FIGS. 11A and 11B each show editing functions displayed in a list box used for setting a graphic-filling where FIG. 11A shows a display when the tape printer “a” is connected, and FIG. 11B is a display when the tape printer “b” is connected, FIGS. 11C and 11D each show editing functions displayed in a margin-setting list box where FIG. 11C shows a display when the tape printer “a” is connected, and FIG. 11D shows a display when the tape printer “b” is connected; and

FIG. 12 is an explanatory drawing for exemplifying a cancel-confirmation screen displayed in the input/edit screen.

### DETAILED DESCRIPTION OF THE PREFERRED EMBODIMENTS

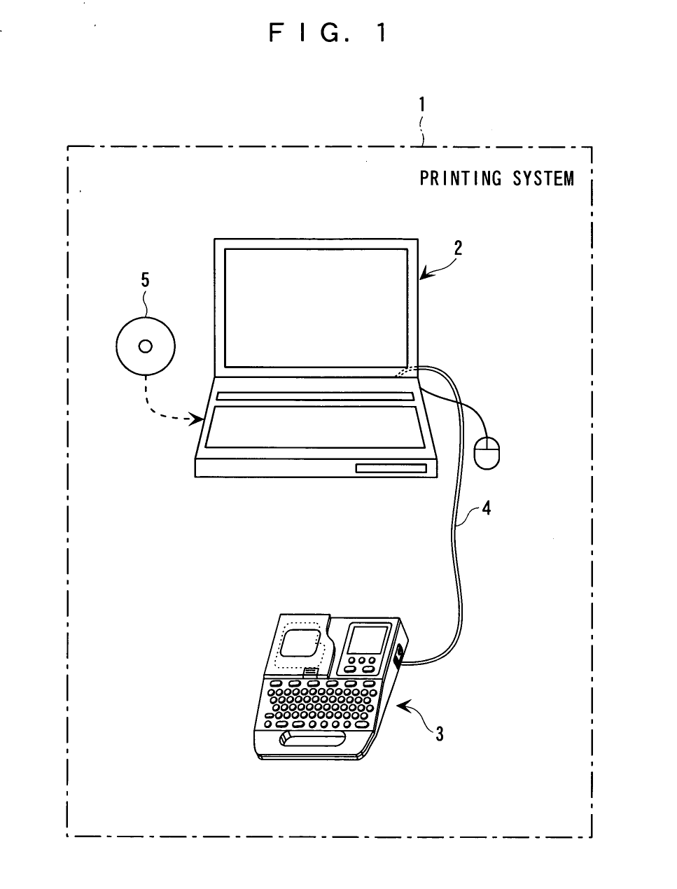

Hereinafter, a printing system to which the present invention is applied will be described with reference to the accompanying drawings. As shown in FIG. 1, the printing system 1 of the present embodiment is comprised of a data-generating apparatus 2, a printing apparatus 3, and a cable 4 for USB-connecting the data-generating apparatus and the printing apparatus to each other, and causes print data generated by the data-generating apparatus 2 to be supplied to the printing apparatus 3. Then the printing system causes the printing apparatus 3 to print a print image based on the print data. The printing system 1 is arranged such that a plurality of types of printing apparatuses 3 can be connected to the data-generating apparatus 2 where model information of the connectable printing apparatuses 3 is to be registered in advance (as will hereinafter be described in detail).

It should be noted that the present embodiment describes a configuration in which the data-generating apparatus 2 and the printing apparatus 3 are directly connected to each other through the cable 4, but alternatively the data-generating apparatus 2 and the printing apparatus 3 may be connected to each other through networks (the Internet or local area networks). In addition, wireless communication may be employed in place of wire communication described in the present embodiment.

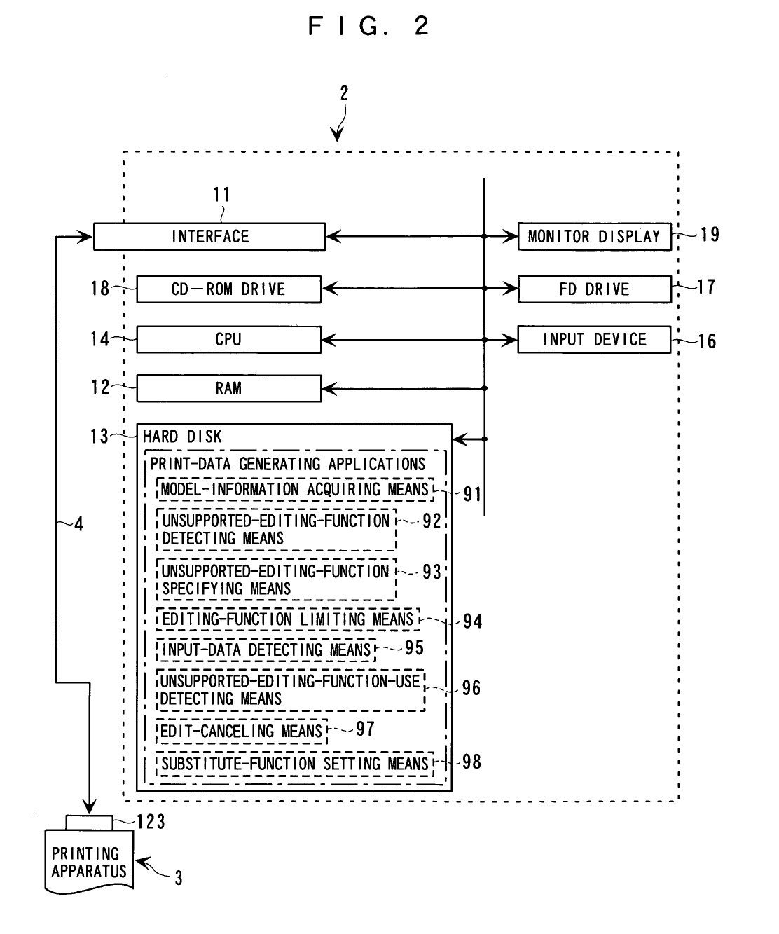

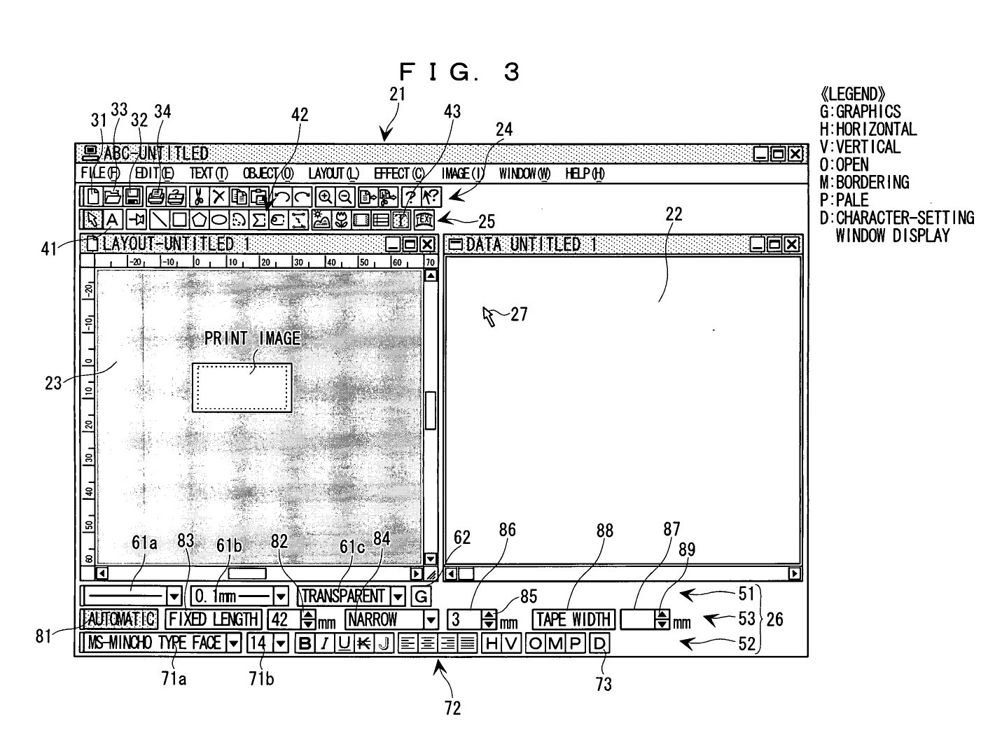

The data-generating apparatus 2 is constituted of a personal computer or the like, and as shown in FIG. 2, is comprised of a USB interface 11 for connecting to the printing apparatus 3 through the cable 4, a RAM 12 having a storage area for temporary storing, which is used as a work area for control processes, a hard disk 13 having various storage areas, which stores generated print data and the model information of the printing apparatus 3 along with control programs and various data, a CPU 14 for calculating the various data based on the programs stored in the hard disk 13, and a bus 15 for connecting the USB interface, the RAM, the hard disk, and the CPU to one another, as well as an input device 16 such as a key board and a mouse, various drives such as a FD (flexible disk) drive 17 and a CD-ROM drive 18, a monitor display 19 for displaying various data such as inputted print data and messages, etc. In the hard disk 13 is installed a software (print-data generating application) for generating print data. In the data-generating apparatus 2, the print-data generating application is activated to display an input/edit screen 21 (see FIG. 3) on a monitor display 19. Then input data is inputted/edited on the input screen to thereby generate print data. It should be noted that input data is treated as print data when it is not edited.

As shown in FIG. 3, on the input/edit screen 21 are displayed a mouse pointer 27, an input/edit window 22 for inputting and editing input data, an image-displaying window 23 for displaying print images of print data generated based on input/edit results, a basic-operation tool bar 24 for basic operations, an input tool bar 25 for inputting characters or graphics as input data, and an edit tool bar 26 for editing input data. Therefore, it is possible not only to input/edit input data with the keyboard, but also to designate inputting of input data and select/set editing functions for use with mouse operation.

The basic-operation tool bar 24 includes a new-preparation button 31 for newly preparing print data, a preservation button 32 for preserving generated print data, a reading button 33 for reading out preserved print data and print data stored in a storage medium 5 such as a CD-ROM and displaying the same in the input/edit window 22 as input data, a print button 34 for printing print data generated from the input data being displayed in the input/edit window 22, etc.

The input tool bar 25 includes a kana-inputting button 41 for inputting kana characters, various-graphics inputting buttons 42 for inputting lines or graphics, a background-pattern setting button 43 for inputting/setting background patterns to be put on the background of inputted input data, etc.

The edit tool bar 26 is constituted of a graphic tool bar 51 for editing inputted graphics, a character tool bar 52 for editing inputted characters, and a label-forming tool bar 53 for forming labels by a tape printer (described later). The graphic tool bar 51 includes three list boxes 61a, 61b, and 61c (pull-down menus) for selecting/setting type, thickness, and filling of border lines (of graphics) from a plurality of alternatives, and a graphic-setting-window displaying button 62 for displaying windows for various settings on graphics.

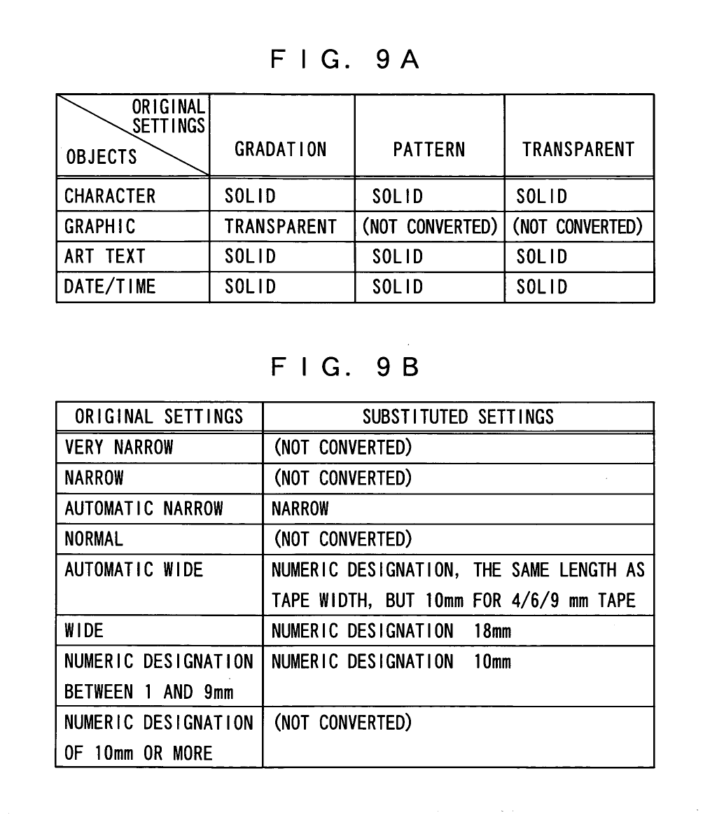

The character tool bar 52 includes list boxes 71a and 71b (pull-down menus) for selecting/setting fonts and sizes of inputted characters, fourteen various setting buttons 72, each for setting styles (bold, italic, underline, etc.), layouts (centering, right justification, etc.), vertical or horizontal writing of inputted characters, character modifications (open or bordering), and a character-setting-window displaying button 73 for displaying windows for various settings on inputted characters. When the character-setting-window displaying button 73 is pressed (selected by the mouse pointer 27), a character-setting screen 74 appears, and in the character-setting screen can be set the above-described fonts, sizes, styles, etc. of the characters, as well as character-filling, character-gradation, and character-intervals by a “character”-setting function, a “gradation”-setting function, and an “interval”-setting function, respectively (see FIG. 9).

The label-forming tool bar 53 includes an automatic-setting button 81 for automatically setting the length of labels to be formed in accordance with inputted input data, a fixed-length setting button 83 for setting the length of labels to be formed to a predetermined length selected by a scroll bar 82, a margin-setting list box 84 (pull-down menu) for selecting/setting the length of margins to be placed next to a print image printed (based on print data), a margin-setting box 86 for setting margins to a predetermined length selected by a scroll bar 85, and a tape-width acquiring button 88 for acquiring a tape width of a tape-shaped member T (described later) mounted on the tape printer (through communication with the printing apparatus 3), and displaying the same in a tape-width displaying box 87. A scroll bar 89 is incorporated in the tape-width displaying box 87 so that the user can input a tape width manually.

Next, the printing apparatus 3 will be described below. The printing apparatus 3 may be constituted by any of a tape printer, an ink jet printer, a laser printer, etc., among which the tape printer is employed as the printing apparatus 3 in this embodiment. The tape printer 101 prints a print image on a tape-shaped member T based on print data, and then cuts off the printed tape-shaped member T to form labels.

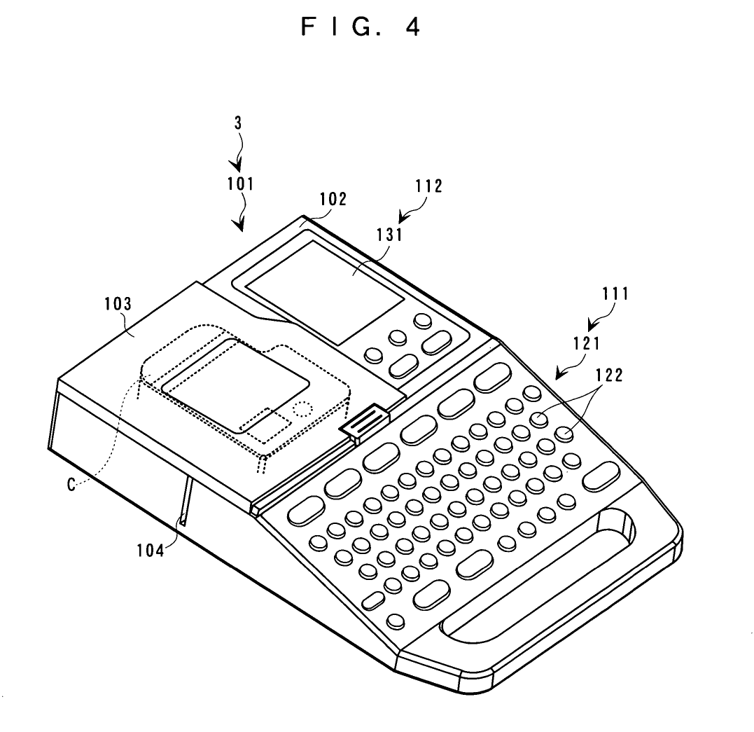

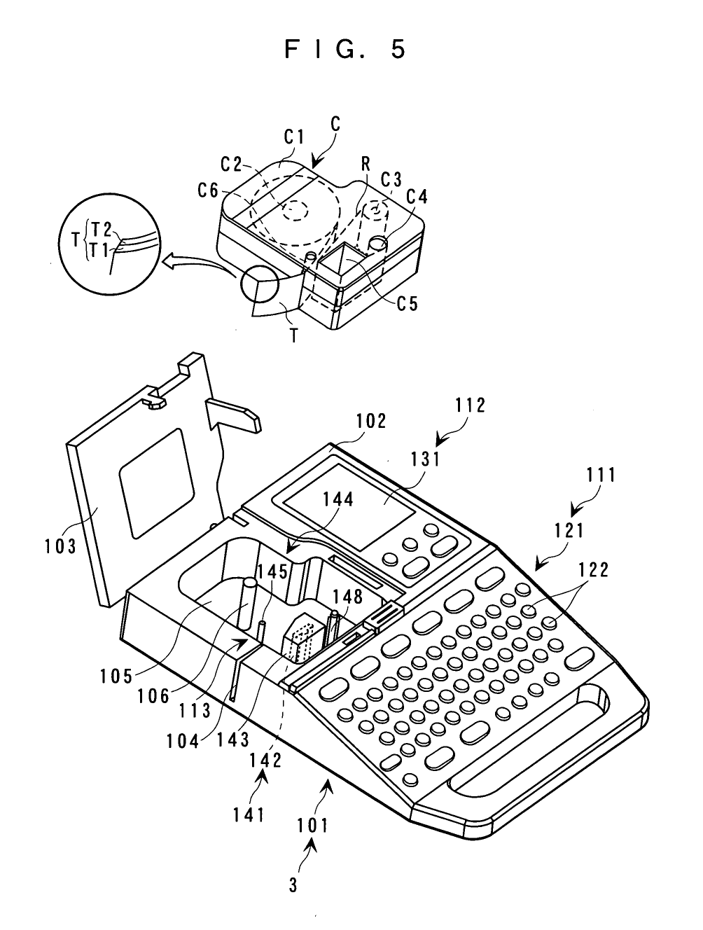

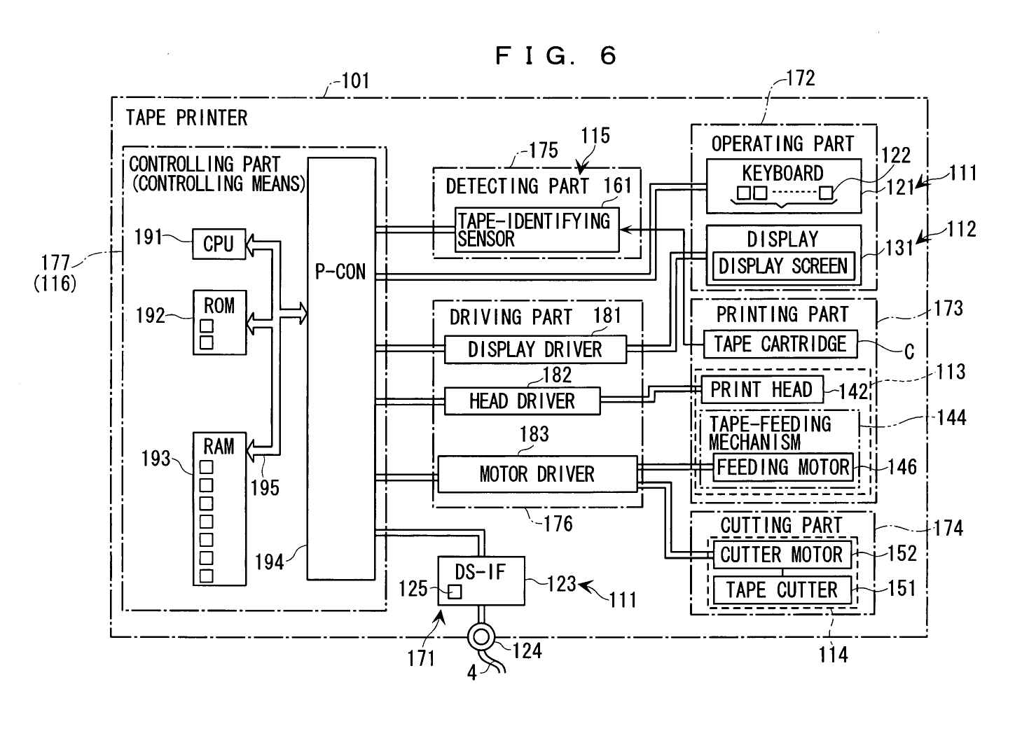

As shown in FIGS. 4 and 5, the tape printer 101 has an outer shell thereof provided by an apparatus casing 102. The apparatus casing 102 has a keyboard 121 including various input keys arranged at a front upper face thereof, an opening/closing lid 103 arranged at the left side thereof, and a display 131 arranged at the right side thereof. Further, the apparatus casing 102 has a tape-discharging port 104 for discharging printed tape-shaped member T arranged at the left-side face of the apparatus casing 102, where a tape cutter 151 for cutting off the discharged tape-shaped member T faces (not shown). Furthermore, although omitted in the figure, the apparatus casing 102 has a USB connector 124 (FIG. 6) for connecting to the USB interface 11 of the data-generating apparatus 2 through the cable 4 arranged at the right side face thereof.

As shown in FIG. 5, inside the opening/closing lid 103 is provided a cartridge-mounting part 105 for removably mounting the tape cartridge C, and a tape-feeding passage (not shown) for feeding the tape-shaped member T from the cartridge-mounting part 105 to the tape-discharging port 104. The cartridge-mounting part 105 has a cartridge-positioning shaft 106 for holding the tape cartridge C in a state at its predetermined position, as well as a platen-driving shaft 145 and a ribbon-rewinding drive shaft 148 (described later) rotatably provided in a standing state (vertical posture). Further, the cartridge-mounting part 105 has a head unit 141 (described later) including a print head 142 vertically provided face to face with the platen-driving shaft 145. In this case, the tape-feeding passage is positioned such that it is sandwiched between the platen-driving shaft 145 and head unit 141. Reference numeral 143 in the figure denotes a head cover for covering the head unit 141.

The tape cartridge C for the tape printer 101 is covered over the entire surface thereof with a cartridge casing C1 as shown in FIG. 5, and includes a tape reel C2 winding the tape-shaped member T in a rolled state, a ribbon-feeding reel C3 winding an ink ribbon R in a rolled state, and a ribbon-rewinding reel C4 for rewinding fed ink ribbon R. Further, the tape cartridge C has a through-hole C5 for loosely inserting the head unit 141 provided therein, and a rotatable platen roller C6 vertically provided such that it faces the through-hole C5. When the tape cartridge C is mounted on the cartridge-mounting part 105, the platen roller C6 and the ribbon-rewinding reel C4 each engage in the platen-driving shaft 145 and the ribbon-rewinding drive shaft 148, thereby making it possible to feed the tape-shaped member T and the ink ribbon R.

The tape-shaped member T is made up of a print tape T1 having an adhesive face and a releasing paper T2 laminated thereon, and can be affixed as a label after being printed. A plurality of types of tape-shaped members T, each having a different type or width, are to be provided in the tape cartridge C, and hence the tape cartridge C has a rear face thereof provided with a plurality of identification holes for identifying the same. In addition, although omitted in the figure, the cartridge-mounting part 105 has a tape-identifying sensor 161 provided (at a bottom plate thereof) such that the type of the tape-shaped member T can be identified through the tape cartridge C in view of an array (bit patterns) of the identification holes provided at the rear face of the tape cartridge C.

Next, a basic configuration of the tape printer 101 will be described below. The tape printer 101 includes an inputting means 111 for inputting print data (containing various setting information, commands, etc.), a displaying means 112 for displaying setting statuses of the tape printer 101 or inputted print data, a printing means 113 for performing printing on the tape-shaped member T based on print data, a cutting means 114 for cutting off a printed tape-shaped member T, a detecting means 115 for detecting various detections, and a controlling means 116 for generally controlling each of the above-described means (see FIG. 6).

The inputting means 111 includes the keyboard 121 having various input keys 122, and a data-supplying interface (DS-IF) 123 for connecting to the data-generating apparatus 2. Thereby, print data can be directly inputted by the use of the various input keys 122 through the keyboard 121, as well as print data of external apparatuses (the data-generating apparatus 2) can be inputted/outputted through the DS-IF 123.

The displaying means 112 includes the display 131 and various display lamps (not shown). The display 131 is arranged such that it has the dimensions of 6 cm in width×4 cm in length, and includes a display screen capable of displaying display image data of 96 dots×64 dots, and 18 indicators (not shown) for indicating various setting statuses or the like.

The printing means 113 performs printing based on print data while reeling out the tape-shaped member T to be fed from the tape cartridge C, and includes a head unit 141 covered with a head cover 143 and having a print head (thermal head) 142, and a tape-feeding mechanism 144 for reeling out the tape-shaped member T to be fed. Although omitted in the figure, the head unit 141 has a head-releasing mechanism incorporated therein, thus allowing the print head 142 to be brought into loose contact with the platen roller C6 in a manner interlocked with the opening/closing lid 103. More specifically, when the opening/closing lid 103 is closed, the print head 142 is pressed to the platen roller C6 through the tape-shaped member T and the ink ribbon R, each facing the through-hole C5. Then the print head 142 drives to produce a state in which thermal transfer can be performed on the tape-shaped member T.

The tape-feeding mechanism 144 includes the platen roller C6 arranged in the tape cartridge C, the platen-driving shaft 145 engaged therewith, a feeding motor 146 for rotating the platen-driving shaft 145, and a feeding-torque transmitting mechanism (not shown) having a speed-reducing gear train for causing the torque of the feeding motor 146 to be transmitted to the platen-driving shaft 145 with its speed decreased. When the feeding motor 146 is driven, the platen roller C6 rotates through the platen-driving shaft 145, followed by feeding of the tape-shaped member T in succession along the tape-feeding passage. It should be noted that the torque of the feeding motor 146 is transmitted also to the ribbon-rewinding drive shaft 148 through the feeding-torque transmitting mechanism, and the platen-driving shaft 145 and ribbon-rewinding drive shaft 148 are such that they rotate in synchronism with each other.

The cutting means 114 is arranged on a downstream side of the tape-feeding direction of the printing means 113, and includes the tape cutter 151 facing the tape-feeding passage, which cuts off the tape-shaped member T, and a cutter motor 152 for causing the tape cutter 151 to perform cutting operation. The detecting means 115 includes various sensors or the like in addition to the tape-identifying sensor 161 in each part of the apparatus. The controlling means 116 is connected to each of the above-described means of the tape printer 101, and controls the entire tape printer 101.

Next, a main controlling system of the tape printer 101 will be described below. As shown in FIG. 6, the tape printer 101 includes a data-inputting/outputting part 171 for inputting/outputting print data or various commands to and from external apparatuses (the data-generating apparatus 2), an operating part 172 for interfacing with the user, a printing part 173 for feeding the tape-shaped member T and printing the same based on print data, a cutting part 174 for cutting off a printed tape-shaped member T, a detecting part 175 for performing various detections, a driving part 176 for driving each of the above-described parts, and a controlling part 177 connected to each of the parts for controlling the entire tape printer 101.

The data-inputting/outputting part 171 has the data-supplying interface (DS-IF) 123, and is arranged such that it communicates with the data-generating apparatus 2 through the USB connector 124. It should be noted that the DS-IF 123 has a receiving buffer 125 arranged therein to receive various data (print data or the like) from the data-generating apparatus 2. The operating part 172 includes the keyboard 121 and the display 131, which allows the user, while viewing input/edit results with the display 131, to input desired characters (texts, numerals, symbols, etc.), graphics or the like with the keyboard 121 so as to input/edit print data and perform various settings. The printing part 173 includes the printing means 113, which causes the print head 142 and the feeding motor 146 to be driven in a manner such that they mutually synchronize with each other, so as to perform printing on the tape-shaped member T while it is being fed from the tape cartridge C. The cutting part 174 includes the cutting means 114, which cuts off the tape-shaped member T at a predetermined position. The detecting part 175 includes the detecting means 115, which contains various sensors such as the tape-identifying sensor 161. The driving part 176 includes various drivers such as a display driver 181 for displaying the display 131, a head driver 182 for driving the print head 142, and a motor driver 183 for driving various motors (the feeding motor 146, the cutter motor 152, etc.).

The controlling part 177 includes a CPU 191, a ROM 192, a RAM 193, and a peripheral controlling circuit (P-CON) 194, all of which are connected to one another by an internal bus 195. The ROM 192 includes an identification-information storing area for storing identification information such as model information and serial numbers inherent in the tape printer 101 for individually identifying the tape printer 101, a control-program area for storing control programs to be processed by the CPU 191, a control-data area for storing font data such as characters (numerals, symbols, graphics, etc.) provided in the apparatus and control data containing e.g. a color-conversion table and a character-modification table. It should be noted that the model information as described herein refers not only to mere types of printing apparatuses such as a tape printer and an ink jet printer, but also a variety of data contained therein.

The RAM 193 has: a print-data area for storing inputted print data; a display-image-data area for storing display-image data generated based on print data and is displayed on the display 131; a print-image-data area for storing print-image data generated based on print data for printing; various buffer areas; and various flags/register groups, and is used as a work area for control processes.

The P-CON 194 has incorporated therein a logic circuit for complementing functions of the CPU 191 and handling interface signals with peripheral circuits through a gate array and a custom LSI. Thus, the P-CON 194 is connected to the various sensors, the keyboard 121, and the DS-IS 124 of the detecting part 175, and receives print data or various detecting signals from the data-generating apparatus 2 or each part of the tape printer 101 into the internal bus 195 as it is or by processing the same. The P-CON 194 then outputs data or control signals outputted to the internal bus 195 from the CPU 191 or the like to the data-generating apparatus 2 and the driving part 176 of the tape printer 101 in a manner interlocked with the CPU 191. The CPU 191 inputs various detecting signals, commands, or data through the P-CON 194 in accordance with control programs in the ROM 192, and processes various data in the RAM 193, followed by outputting the control signals to the driving part 176 through the P-CON 194.

Now, the control process in which print data generated by the data-generating apparatus 2 is printed by the tape printer 101 will be described below. When the print button 34 on the input/edit screen 21 of the data-generating apparatus 2 is selected in succession to generation of print data, the print data is transmitted to the tape printer 101 through the USB interface 11. Then the print data is temporarily stored in the receiving buffer 125 of the DS-IF 123, and a print-processing command is inputted to the CPU 191 through the P-CON 194. Subsequently, print image data is developed from the print data in response to the control program of the ROM 192, and the control signal based on the print image data is then outputted to the driving part 176 from the CPU 191 through the P-CON 194. Thereby, the print head 142 and the tape-feeding mechanism 144 (the feeding motor 146) are driven in synchronism with each other, and upon completion of tape feeding, the cutter motor 152 is driven at the given time to form a label printed with the print image.

It should be noted that the data-generating apparatus 2 is provided with multiple editing functions by means of which a variety of editing processes can be performed with respect to input data in the input/edit screen 21. However, as described above, since the printing system 1 can be connected with a plurality of types of printing apparatuses 3, it is expected that the plurality of types of printing apparatuses 3, each having a different printing function, are to be connected. In such a case, some of the editing functions of the data-generating apparatus are not supported by the printing functions of the connected printing apparatus 3. Therefore, when print data is generated by the use of the editing function not supported by the printing functions of the printing apparatus (unsupported editing function), a print image displayed in the data-generating apparatus 2 (the image-displaying window 23) and an actual print result by the printing apparatus 3 are caused to disagree with each other. In the light of the above, in the printing system 1 of the present embodiment, after the printing apparatus 3 is connected to the printing system (data-generating apparatus), use of the unsupported editing function of the data-generating apparatus 2 is limited according to the connected printing apparatus 3, thereby making it possible to prevent such disagreement from occurring.

On the other hand, in the case where print data has been generated before the printing apparatus 3 is connected to the printing system, it is not possible to specify or limit the use of the unsupported editing function in generating the print data. In other words, the print data having been generated before the printing apparatus 3 is connected to the printing system may be generated by the use of the unsupported editing function, and hence a print image of the generated print data and an actual print result are caused to disagree with each other. Thus, in the present embodiment, when print data has been generated before the printing apparatus 3 is connected to the printing system, the print data is converted (replaced) in accordance with the connected printing apparatus 3, thereby making it possible to reliably reduce print errors caused by disagreement between the print image and the actual print result.

First, a method of limiting the editing functions after the printing apparatus 3 is connected to the printing system will be described below. As described above, the data-generating apparatus 2 has registered therein model information of any connectable printing apparatuses 3 in advance. Each of the registered model information is correlated with the editing functions possessed by the data-generating apparatus 2, based on the printing functions of the printing apparatus 3 having the model information. In the present embodiment, the editing functions are classified into common editing functions supported by any connectable printing apparatuses 3 and having a plurality of types of editing functions, and individual editing functions the supports of which are provided/not provided depending on (the printing functions of) the connected printing apparatus 3 and having a plurality of types of editing functions. Each of the registered model information is correlated only with the plurality of types of editing functions constituting the individual editing functions. More specifically, the data-generating apparatus has stored therein a database indicating whether or not each editing function of the individual editing functions is recognized as the editing function not supported by the printing apparatus 3 having the model information by causing the same to correspond to each model information. Accordingly, only the individual editing functions are caused to correspond to the model information, thereby restraining a data amount of the database.

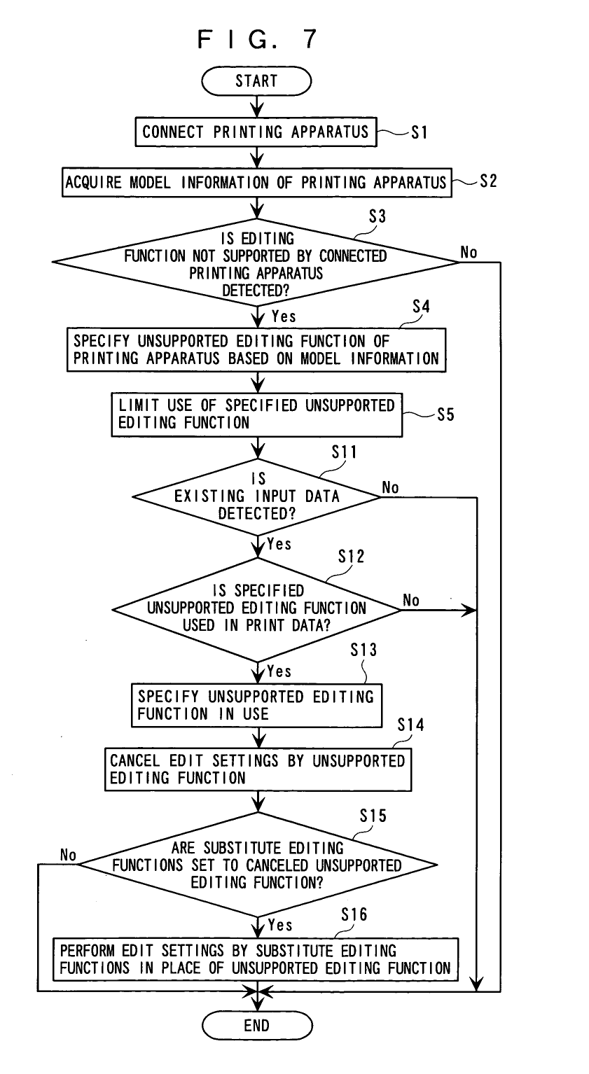

Further, the data-generating apparatus 2 includes a model-information acquiring means 91 for acquiring the model information of the printing apparatus 3, and limits the editing functions based on the acquired model information and the database. Now referring to FIG. 7 (as well as FIG. 2), a series of flows regarding the limitation of the editing functions after the printing apparatus 3 is connected to the printing system will be described. As shown in the figure, when the printing apparatus 3 is connected to the printing system 1 (S1), the model-information acquiring means 91 transmits a request for acquiring the model information, and receives the same from the printing apparatus 3 (S2). Subsequently, an unsupported-editing-function detecting means 92 refers to records of the database based on the acquired model information, and detects presence or absence of the editing function not supported by the connected printing apparatus 3 (S3). If the unsupported editing function is detected (S3: Yes), an unsupported-editing-function specifying means 93 specifies the editing function not supported by the connected printing apparatus 3 (from the individual editing functions) (S4). Then an editing-function limiting means 94 limits display of the editing function recognized as the specified unsupported editing function, and limits use (or selection) of the unsupported editing function (S5).

Although omitted in the figure, the data-generating apparatus 2 has a connection-detecting sensor provided for electrically detecting connection of the data-generating apparatus 2 and the printing apparatus 3. Upon receiving connection-detecting signals of the printing apparatus 3 by the connection-detecting sensor as a trigger, the model-information acquiring means 91 makes a request for acquiring the model information.

Next, a method of converting print data having been generated before the printing apparatus 3 is connected to the printing system will be descried below. Conversion of print data is performed after the printing apparatus 3 is connected to the printing system, with respect to the print data having been generated before the printing apparatus 3 is connected to the printing system. As shown in FIG. 7, the conversion of print data is performed after the series of flows (S1 to S5) in the use limitation of the editing functions after the printing apparatus 3 is connected to the printing system. After the use of the unsupported editing function is limited (S5), first, an input-data detecting means 95 detects whether or not input data has been inputted to the input/edit screen 21 (S11). If existing input data is detected (S11: Yes), an unsupported-editing-function-use detecting means 96 detects whether or not the print data generated based on the input data contains the edit settings by the unsupported editing function specified by the flow in the use limitation of the editing functions, i.e. whether or not the unsupported editing function has been used (S12).

If the use of the unsupported editing function is detected (S12: Yes), the data-generating apparatus specifies the unsupported editing function in use (S13), and the edit settings of the print data performed by the specified unsupported editing function are canceled by an edit-canceling means 97 (S14). In this case, the edit settings by the specified unsupported editing function may be forcibly canceled in whole, or alternatively the user may cancel the edit settings based on cancel confirmation for selecting whether or not the edit settings by the specified unsupported editing function should be canceled. Further, the cancel confirmation for the edit settings may be individually performed for each of the specified unsupported editing function to cancel only the edit settings by the unsupported editing function which is permitted to be canceled. The present embodiment exemplifies a case where the use of the unsupported editing function is detected in print data and the edit settings by the unsupported editing function are canceled based on the specified unsupported editing function. However, the edit settings by all the unsupported editing functions of the connected printing apparatus 3 may be canceled in whole without detecting and specifying the use of the unsupported editing function.

After the edit settings by the unsupported editing function are canceled (S14), the data-generating apparatus confirms whether or not the canceled unsupported editing function has a predetermined editing function as substitute editing functions (S15). If it has the substitute editing functions (S15: Yes), a substitute-function setting means 98 performs the edit settings by the substitute editing functions in place of the canceled unsupported editing function (S16). Here, in a way similar to the case where the edit settings by the unsupported editing function are canceled, the edit settings by the substitute editing functions may be forcibly performed, or alternatively the user may select whether or not the edit settings by the substitute editing functions should be performed.

According to the series of operations described above, print data is converted, as well as a display image (print image) displayed in the input/edit window 22 and the image-displaying window 23 of the input/edit screen 21 is also converted based on the converted print data. In other words, when the edit settings by the substitute editing functions are performed, a print image is turned into one reflecting the edit settings by the substitute editing functions. On the other hand, only when the edit settings by the unsupported editing function is canceled, a print image is turned into one not subjected to the edit settings by the unsupported editing function. Thus, when print data is converted in this manner, it is preferable that a setting modification be displayed for indicating cancellation or modification of the edit settings by the unsupported editing function.

Although the edit settings by the unsupported editing function cannot be performed, it is arrange to be able to edit print data even after conversion. For example, it is possible to cancel the edit settings by the substitute editing functions and to perform new edit settings by editing functions except for the substitute editing functions. Further, existing print data is replaced by the converted print data under a new preservation setting (through the preservation button 32 or the like) and preserved. In other words, the existing print data remains unchanged until new preservation is set, thereby allowing repeated use of the existing print data.

Further, when print data is read out from the storage medium 5 such as a CD-ROM and a FD (flexible disk) after the printing apparatus 3 is connected to the printing system, there arises a problem generally similar to the case in which print data has been generated before the printing apparatus 3 is connected to the printing system. Therefore, in the case where the series of operations from the limitation of the editing functions to the conversion of print data have been completed when the print data is read out from the storage medium, the series of operations in the converting operation of the print data from S12 to S16 are performed as in the case where the print data has been generated before the printing apparatus 3 is connected to the printing system, followed by the conversion of the read-out print data. On the other hand, in the case where print data has been read out from the storage medium before the printing apparatus 3 is connected to the printing system, the operation similar to the case where print data has been generated before the printing apparatus 3 is connected to the printing system is performed, and the operations of S1 to S16 are to be performed when the printing apparatus 3 is connected to the printing system.

It should be noted that the various editing functions of the data-generating apparatus 2 and the above-described series of operations are to be implemented based on print-data generating applications, and each of the means used in the series of operations (the model-information acquiring means 91, the unsupported-editing-function detecting means 92, the unsupported-editing-function specifying means 93, the editing-function limiting means 94, the input-data detecting means 95, the unsupported-editing-function-use detecting means 96, the edit-canceling means 97, the substitute-function setting means 98, etc.) is a virtual means implemented by calculation of the CPU 14 of the data-generating apparatus 2 based on the print-data generating applications (see FIG. 2). In addition, the database of the print-data generating applications is stored in the hard disk 13 of the date-generating apparatus.

Next, specific operations in the use limitation of the editing functions and the conversion of print data will be described below. The printing system to be used for explanation is arranged such that a tape printer “a” having a print resolution of 360 dpi and model information of A, and a tape printer “b” having a print resolution of 180 dpi and model information of B can be connected to the printing system.

In the printing system, the following are classified into the individual editing functions: a “transparent”-filling function and a “pattern”-filling function set by filling of a “character”-setting function in the character-setting screen 74; a “gradation”-setting function of the character-setting screen 74, and a “gradation”-setting function pertaining to filling of graphics; a “background-pattern”-setting function regarding background-pattern settings to be put on backgrounds of print data; and settings to “automatic narrow,” “automatic wide,” “wide,” and “numeric designation between 1 and 9 mm” in the margin-setting list box 84. In addition, the filling of the “character”-setting function includes “transparent” and “pattern”-filling functions as the individual editing functions, as well as “solid,” “open,” and “bordering” functions as the common editing functions. Further, in the margin-setting list box 84, “very narrow,” “narrow,” “normal,” and “numeric designation of 10 mm or more” can respectively be selected as the common editing functions.

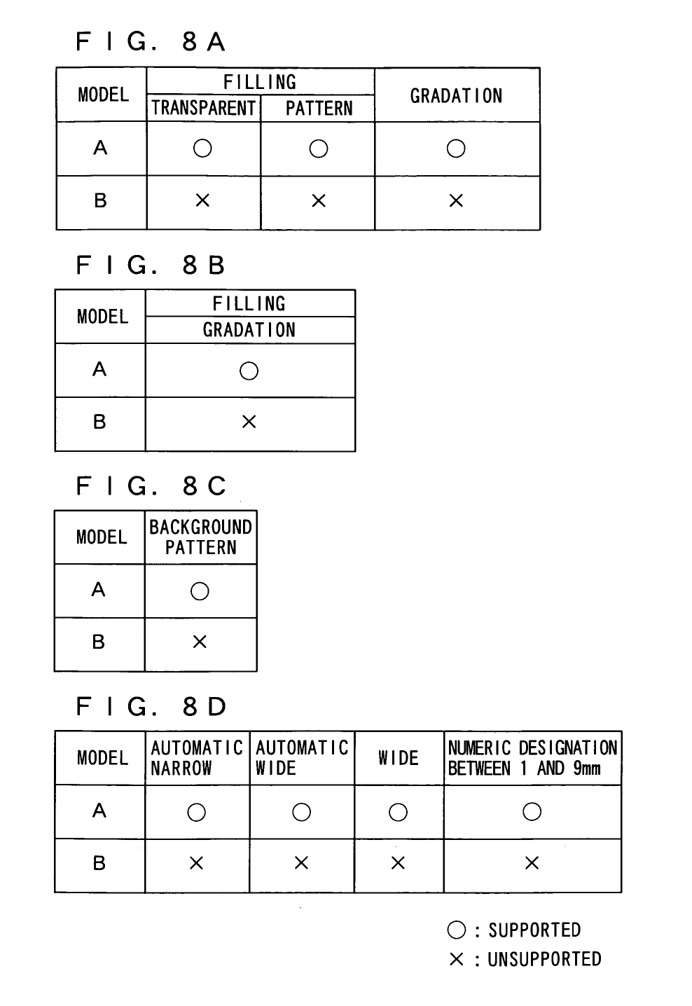

FIG. 8 shows contents of the database in which each of the model information of A and B is caused to correspond to the individual editing functions of the printing system 1. As shown in the figure, each of the editing functions constituting the individual editing functions is supported only by the tape printer “a.” FIG. 9 shows the substitute editing functions set to each of the editing functions constituting the individual editing functions. Each of the editing functions of the individual editing functions has set therein the substitute editing functions except for the “background-pattern”-setting function.

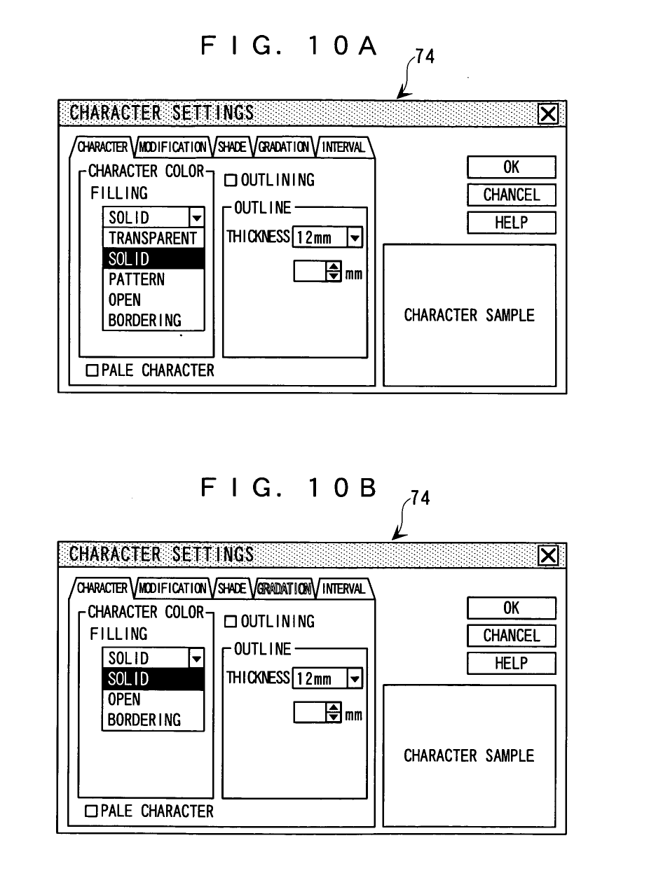

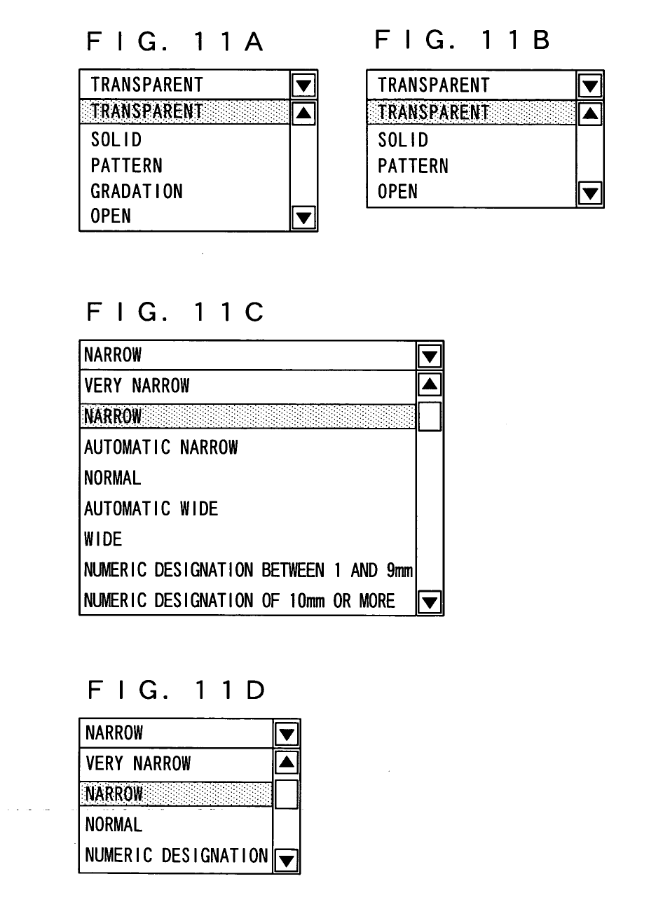

On one hand, when the tape printer “a” is connected to the printing system, the model information of A is obtained. In this case, since the unsupported editing function corresponding to the model information of A is not detected (see FIG. 8), display limitation of the individual editing functions is not imposed. Now referring to FIGS. 10A, 11A, and 11C wherein: FIG. 10A shows the character-setting screen displayed when the tape printer “a” is connected to the printing system; FIG. 11A shows the editing functions displayed in the list box for setting the filling of graphics; and FIG. 11C shows the editing functions displayed in the margin-setting list box, the character-setting screen 74, the list box 61c for setting the filling of graphics, and the margin-setting list box 84 are displayed such that all the editing functions can be selected for setting. Further, when print data has been generated before the tape printer “a” is connected to the printing system, the print data is not converted.

On the other hand, when the tape printer “b” is connected to the printing system, the model information of B is obtained. Then the unsupported editing function corresponding to the model information of B is detected, as well as each of the following functions is specified as the unsupported editing function: the “transparent”-filling function, the “pattern”-filling function, and the “gradation”-setting function of characters; the “gradation”-setting function of graphics; the “background-pattern”-setting function; and the “automatic-narrow”-setting function, the “automatic-wide”-setting function, the “wide”-setting function, and the setting function of “numeric designation between 1 through 9 mm.” Thus, the display of all the specified editing functions is limited.

Specific descriptions will be made with reference to FIGS. 10B, 11B, and 11D below. The figures are each diagrams explaining states when the tape printer “b” is connected to the printing system. FIGS. 10B, 11B, and 11D show the character-setting screen, the list box for setting the graphic-filling, and the margin-setting list box, respectively. In the character-setting screen 74, the display of the “transparent”-filling function and the “pattern”-filling function is not provided, as well as the display of the “gradation”-setting function is grayed out, thereby prohibiting the user from selecting the “transparent”-filling function, the “pattern”-filling function, and the “gradation”-setting function regarding the edit settings of characters. Further, the display of the “gradation” is eliminated from the list box 61c used for setting the graphic-filling, and the displays of the “automatic narrow,” the “automatic wide,” the “wide,” and the “numeric designation between 1 and 9 mm” are eliminated from the margin-setting list box 84. Furthermore, although omitted in the figure, the background-pattern setting button 43 for the “background-pattern” setting is grayed out in the screen, thereby prohibiting the user from selecting the background-pattern setting button 43. It should be noted that the user can arbitrarily set the display limitation of the editing functions as to the settings whether the display itself should be eliminated or the display should be grayed out.

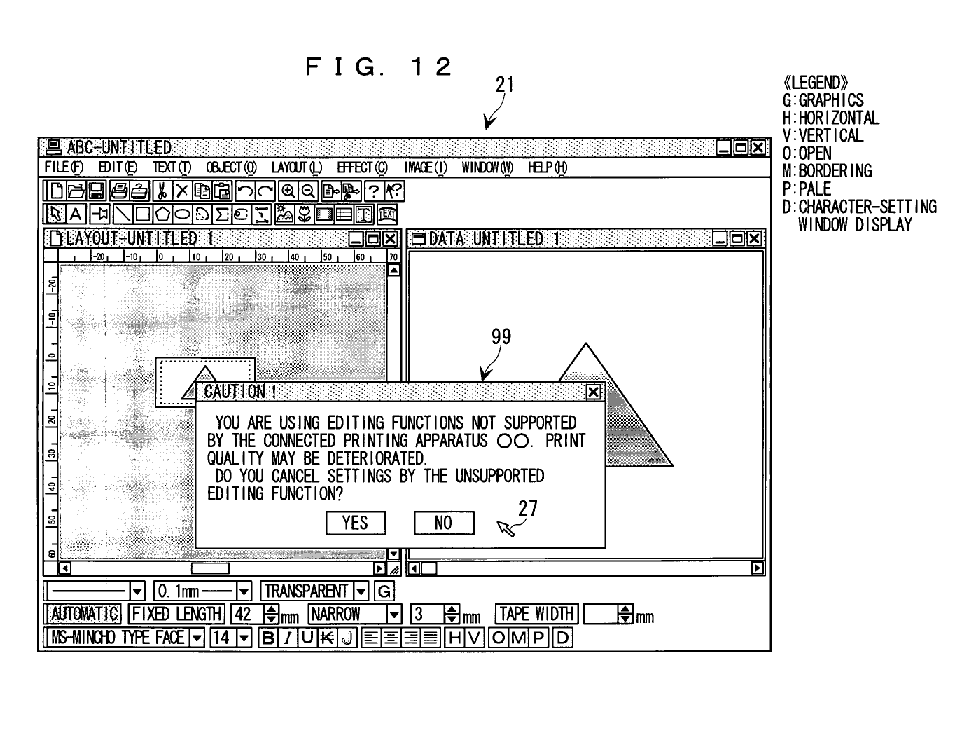

When print data has been generated in the input/edit screen 21 before the tape printer “b” is connected to the printing system, the print data is converted. Here, let it be assumed that the “gradation”-setting function for editing characters, the “background-pattern”-setting function, and the “automatic-narrow”-setting function in the margin-setting are used in the print data. In this case, first, use of the unsupported editing function is detected. Subsequently, the cancel-confirmation screen 99 is displayed as shown in FIG. 12, and the cancel-confirmation for the edit settings by the unsupported editing function is made. When the cancellation for the edit settings by the unsupported editing function is approved, the edit settings by the “gradation”-setting function, the “background-pattern”-setting function, and the “automatic-narrow”-setting function are canceled, as well as the data-generating apparatus confirms whether or not the substitute-editing functions are provided therein. In this case, it is confirmed that the “gradation”-setting function and the “automatic-narrow”-setting function each have the substitute editing functions. Namely, the edit setting by the “solid”-filling function in place of the “gradation”-setting function, and the edit setting by the “narrow”-setting function in place of the “automatic-narrow”-setting function are to be performed. On the other hand, since the “background-pattern”-setting function has not set therein the substitute-editing functions, the edit setting by the “background-pattern”-setting function is held in a canceled state. Due to the cancellation of the edit settings by the unsupported editing function and the substitution of the substitute editing functions for the unsupported editing function, the print data is converted, and a display image (print image) in the input/edit screen 21 is also converted.

Thus, in this embodiment, it is possible to limit the use of the editing functions according to the connected printing apparatus 3, as well as to convert print data according to (the printing functions of) the connected printing apparatus 3 even if it has been generated before the printing apparatus 3 is connected to the printing system. Therefore, a print image displayed in the input/edit screen 21 and an actual print result can be generally agreed with each other, resulting in prevention of print errors caused by the user. Further, due to the use limitation function of the editing functions, it is possible to enhance expandability of the printing system 1 of the present embodiment. For example, if a printing system to which a printing apparatus “A” can be connected is arranged such that a printing apparatus “B” having a different printing function can be connected thereto, it is desirable that printing functions of the printing apparatus “A” and the printing apparatus “B” be divided into common functions and different functions. Thus, the different printing functions must be considered to set individual functions. In such a case, the common functions can be made based on settings of the printing apparatus “A,” thereby making it possible to efficiently construct the printing system.

It should be noted that the present embodiment refers to the printing system 1 in which the data-generating apparatus 2 is connected with one printing apparatus 3. Alternatively, a plurality of printing apparatuses 3 can be connected to the data-generating apparatus 2. In this case, every time a second and subsequent printing apparatuses 3 are connected to the data-generating apparatus, the above-described series of operations from the use limitation of editing functions to the conversion of print data are to be performed in generally a similar manner. However, in the printing system, the editing functions supported by the later-connected printing apparatus 3 are specified out of the editing functions the use of which is limited as the unsupported editing function, and operation for canceling the use limitation is additionally performed. In other words, only the use of the unsupported editing function common to the previously-connected printing apparatus 3 and the later-connected printing apparatus 3 is limited. Further, when print data is converted, only the edit settings by the unsupported editing function common to the plurality of connected printing apparatuses 3 are converted with respect to the existing print data before being converted.

For example, assuming that the printing system 1 in which use of editing functions “a,” “b,” and “c” is limited as the editing function not supported by the previously-connected printing apparatus 3 is connected with the printing apparatus 3 supporting the editing function “b,” the editing function “b” is specified as well as use limitation of the same is canceled. Then the data-generating apparatus confirms whether or not print data (input data) has been generated before the printing apparatus 3 supporting the editing function “b” is connected to the printing system. If the print data has been generated, the data-generating apparatus further confirms whether or not the cancellation of the edit settings by the editing function “b” or the substitute setting for the editing function “b” has been performed in generating the print data. If the cancellation/substitution of the editing functions by the editing function “b” has been performed, the data-generating apparatus then cancels the edit settings and performs again the edit settings by the editing function “b.”

When the generated print data is printed, the data-generating apparatus 2 causes the user to select the printing apparatus 3 for printing, out of the plurality of connected printing apparatuses 3, and transmits the print data to the selected printing apparatus 3. At this time, if the print data contains the unsupported printing function (of the printing apparatus 3 selected by the user) therein, the print data is converted in a way similar to the method of converting the print data described above. In addition, the data-generating apparatus 2 has included therein an automatic-selecting mode which automatically selects the printing apparatus 3 based on the generated print data to transmit the print data. In the automatic-selecting mode, the (individual) editing functions used for generating print data are searched, and the printing apparatus 3 supporting all the searched editing functions is selected out of the plurality of connected printing apparatuses 3. If there is no printing apparatus 3 supporting all the searched editing functions, however, the system switches to the mode in which the user selects the printing apparatus 3.

It should be noted that in the data-generating apparatus 2, the printing apparatus 3 for printing can be selected and set in advance out of the plurality of connectable printing apparatuses when input data is inputted/edited. When the printing apparatus 3 for printing is set, the limitation of the editing functions and the conversion of print data are performed immediately in conformity with the set printing apparatus 3. Even if another printing apparatus is connected to the printing system after the printing apparatus 3 is set, the series of operations described above will not be allowed.

As described above, according to the printing system of the present invention, the editing functions which may cause improper print results are specified as the unsupported editing function and the use thereof is limited, thereby preventing disagreement between the user's print images based on the generated print data and actual print results from occurring. Further, due to the use of the unsupported editing function being limited, it is possible to prevent the user from erroneously using the unsupported editing function, thereby enhancing the user's convenience and ease of operation.

It is further understood by those skilled in the art that the foregoing is the preferred embodiment of the invention, and that various changes and modifications may be made without departing from the spirit and scope thereof.

1. A printing system arranged such that a plurality of types of printing apparatuses, each having a different printing function for proper printing, can be connected to a data-generating apparatus through an interface, thereby causing the printing apparatuses to perform printing based on print data generated by the data-generating apparatus, wherein
the plurality of types of printing apparatuses comprise model information inherent in each model, and
the data-generating apparatus comprises:
a data-inputting means for inputting input data;
a data-editing means having an editing function for editing the input data inputted and generating the print data;
a database-storing means for storing a database which correlates all model information with the editing function possessed by the plurality of types of printing apparatuses based on the printing function;
a model-information acquiring means for acquiring model information of the connected printing apparatus;
a function-specifying means for specifying as an unsupported editing function the editing function not supported by the printing function of the connected printing apparatus in view of the acquired model information, based on the database; and
a function-limiting means for limiting use of the specified unsupported editing function.

2. The printing system according to claim 1, wherein the data-generating apparatus further comprises:
an input-data detecting means for detecting whether or not the input data has been inputted upon being connected to the printing apparatus; and
a canceling means for canceling an edit by the unsupported editing function when the input data is detected by the input-data detecting means.

3. The printing system according to claim 2, wherein the data-editing means has a plurality of types of editing functions, and the data-generating apparatus further comprises a substitute-function setting means for setting a substitute editing function supported by the printing apparatus in place of the canceled unsupported editing function.

4. A method of controlling a printing system arranged such that a plurality of types of printing apparatuses, each having a different printing function for proper printing, can be connected to a data-generating apparatus through an interface, thereby causing the printing apparatuses to perform printing based on print data generated by the data-generating apparatus, wherein
the plurality of types of printing apparatuses comprise model information inherent in each model, and
the data-generating apparatus has an editing function for editing input data inputted and generating print data, and correlates all model information with the editing function possessed by the plurality of types of printing apparatuses based on the printing function and stores the same, the method comprising the steps of:
acquiring the model information of the connected printing apparatuses;
specifying as an unsupported editing function the editing function not supported by the printing function of the connected printing apparatus in view of the acquired model information; and
limiting use of the specified unsupported editing function.
